(19) United States
(12) Patent Application Publication
(10) Pub. No.: US 2007/0213056 A1
(43) Pub. Date: Sep. 13, 2007

(54) METHOD OF PERFORMING HANDOVER IN A BROADBAND WIRELESS ACCESS SYSTEM

(76) Inventors: Bin Chul Im, Gyeonggi-do (KR); Yong Suk Jin, Gyeonggi-do (KR)

Correspondence Address: LEE, HONG, DEGERMAN, KANG & SCHMADEKA, 660 S. FIGUEROA STREET, Suite 2300, LOS ANGELES, CA, 90017, US

(21) Appl. No.: 11/573,090

(22) PCT Filed: Aug. 1, 2005
(86) PCT No.: PCT/KR05/02504

§ 371 Date: Feb. 1, 2007

(30) Foreign Application Priority Data
Aug. 2, 2004 (KR) 1020040060821

(51) Int. Cl. H04Q 7/20

(52) U.S. Cl. 455/436

(57) ABSTRACT

The present invention relates to a method of performing handover and a method of supporting handover in a broadband wireless access system for minimizing service transmission delay during handover. The present invention discloses a technical feature that the mobile station determines the target base station for handover in consideration of information related to data transmission time necessary for transmitting data from the serving base station to the target base station.

### TECHNICAL FIELD

The present invention relates to a broadband wireless access system, more particularly, to a method of performing handover and a method of supporting handover in a broadband wireless access system for minimizing service transmission delay during handover.

### BACKGROUND ART

FIG. 1 is a diagram illustrating a procedure executing handover in accordance with the related art. Referring to FIG. 1, a mobile station (MS) measures strength of signals received from at least one neighbor base stations and makes an active set list. The mobile station reports to a the neighbor base stations included in the active set list to a serving base station.

During performing handover including a fast cell switching, the mobile station is received downlink/uplink control messages or data from one of the neighbor base station included in the active set list. The serving base station transmits a list of target base stations for handover among the neighbor base stations in the active set list through a handover request or response message. The mobile station selects, if strength of signals received from the serving base station is getting weaker, a target base station based on signal strength and service level prediction, and performs handover such that the mobile station can receive data from the target base station seamlessly.

In the related art, as described above, when the mobile station determines the target base station, the signal strength and the service level prediction are considered. However, it is difficult to provide services (especially, delay-sensitive services) smoothly before and after the handover, if unnecessary delay occurs when transmitting data from the serving base station to the target base station determined based on the signal strength and the service level prediction.

### DISCLOSURE OF INVENTION

Accordingly, the present invention is directed to a method of performing handover and a method of supporting handover in a broadband wireless access system that substantially obviates one or more problems of the related art. The object of the present invention is to provide a method for minimizing service delay during handover between a serving base station and a neighbor base station.

As described above, the most important factors when a mobile station determines a target base station during handover is strength of reference signals (like pilot signals) from neighbor base stations and/or service level prediction. Namely, a neighbor base station which transmits the strongest reference signals and has higher service level prediction among the neighbor base stations is generally determined as the target base station, and the mobile station performs handover to the determined target base station.

However, if the mobile station is receiving a delay-sensitive service from the serving base station before handover and the target base station is determined based on the strength of the reference signals and the service level prediction, the mobile station may have difficulty in receiving the service after handover since there can be such a case that data transmission from the serving base station to the target base station is delayed too much.

To prevent such a case, the present invention discloses a technical feature that the mobile station determines the target base station for handover in consideration of information related to data transmission time necessary for transmitting data from the serving base station to the target base station.

Examples of the information related to data transmission time may preferably include actual time for data transmission or hop counts from the serving base station to each of the neighbor base stations. Further, it is possible for the serving base station to acquire the information related to data transmission time and provide mobile stations with the information whenever handover is performed. It is more preferable, however, for the serving base station to store the information related to data transmission time and to provide the mobile stations with the information as necessary.

In accordance with one aspect of the present invention, a method of performing handover at a mobile station (MS) receiving a service from a serving base station (BS) in a broadband wireless access system is disclosed, and the method comprises the steps of acquiring information related to data transmission time necessary for transmitting data from the serving base station to at least one neighbor base station; determining a target base station based on determination factors including the information related to data transmission time; and receiving the service from the determined target base station.

In accordance with another aspect of the present invention, a method of performing handover in a mobile station (MS) is disclosed, and the method comprises the steps of determining a target base station based on data transmission time necessary for transferring data from a serving base station to at least one neighbor base station, the data transmission time being calculated from received information from the serving base station; and transmitting information associated with the determined target base station to the serving base station.

In accordance with another aspect of the present invention, a method of supporting handover of a mobile station (MS) receiving a service from a serving base station (BS) in a broadband wireless access system is disclosed, and the method comprises the steps of providing information related to data transmission time necessary for transmitting data from the serving base station to at least one neighbor base station; receiving information associated with a target base station determined by the mobile station among the at least one neighbor base station based on at least one determination factors including information related to data transmission time; and transmitting data for the service to the target base station.

### BRIEF DESCRIPTION OF DRAWINGS

The accompanying drawings, which are included to provide a further understanding of the invention and are incorporated in and constitute a part of this application, illustrate embodiments of the invention and together with the description serve to explain the principles of the invention.

FIG. 1 is a diagram illustrating a procedure executing handover in accordance with the related art.

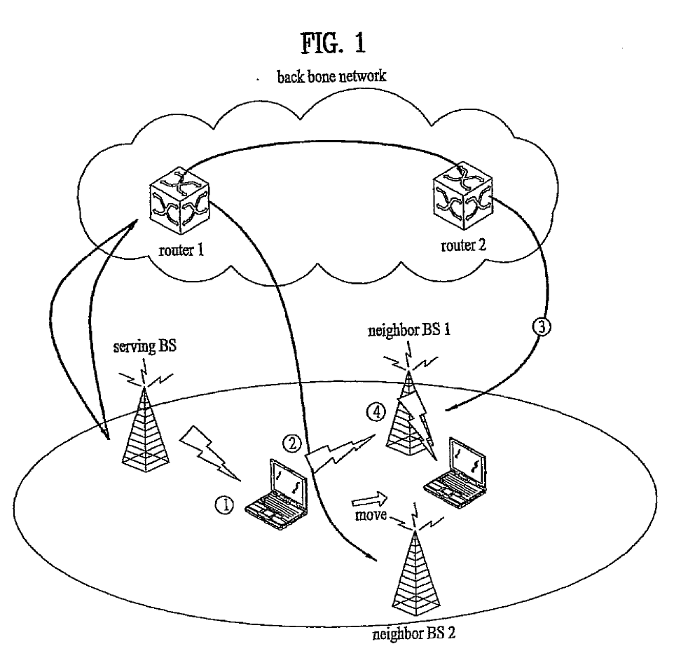

FIG. 2 is a flowchart illustrating a procedure in accordance with a preferred embodiment of the present invention.

### BEST MODE FOR CARRYING OUT THE INVENTION

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

Embodiments described below are examples with which technical features of the present invention are applied in a broadband wireless access system. It should be appreciated by those having ordinary skill in the art that the technical features of the present invention can be applicable to other wireless communications systems as well as the broadband wireless access system.

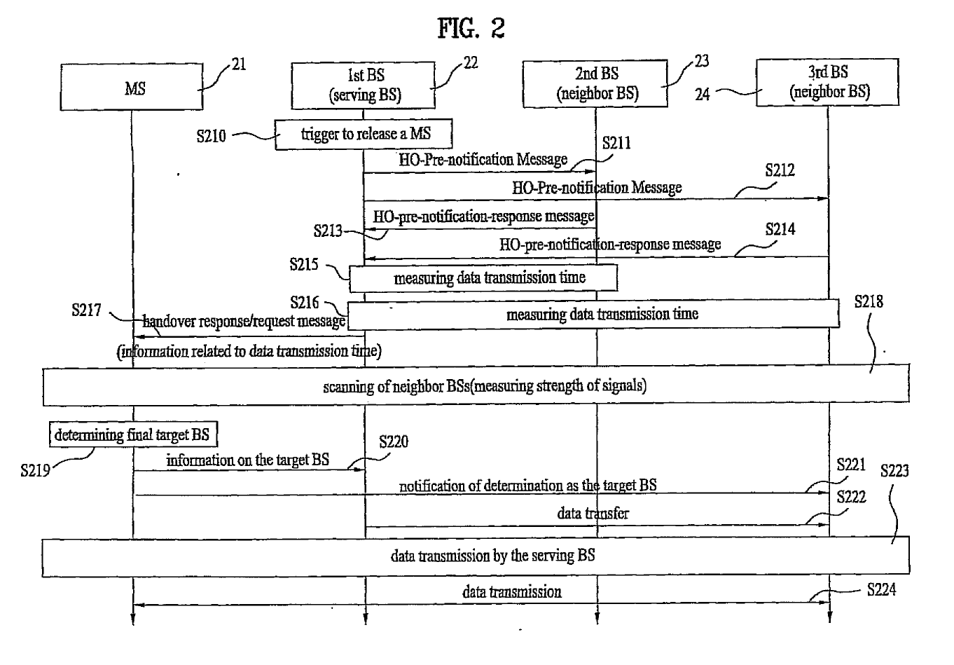

FIG. 2 is a flowchart illustrating a procedure in accordance with a preferred embodiment of the present invention. Referring to FIG. 2, the serving base station (22) triggers to release a mobile station (21) on its own decision [S210]. Alternatively, the mobile station (21) requests handover to the serving base station (22) when the mobile station (21) considers handover is necessary, for example, when difference between strength of reference signals of the serving base station (22) and that of one of neighbor base stations is less than a threshold.

The serving base station (22) transmits to the neighbor base stations (23, 24) HO-pre-notification messages for notifying the necessity of handover [S211, S212]. The HO-pre-notification message includes an MS identifier identifying the mobile station (21) requesting handover, connection parameters, capabilities, required bandwidth, and information associated with service level prediction, The information associated with the service level prediction means information on grade or level of support which the neighbor base stations (23, 24) can provide for services provided to the mobile station (21) by the serving base station (22).

The neighbor base stations (23, 24) transmit HO-pre-notification response messages to the serving base station (22) in response to the HO-pre-notification messages [S213, S214]. The HO-pre-notification response message includes reception acknowledge information (ACK or NAK) of the HO-pre-notification message and the service level prediction. The service level prediction preferably includes quality of service (QoS) and can be expressed in a form of grade or level.

The serving base station (22) may measure data transmission time necessary for transmitting data from the serving base station (22) to each of the neighbor base stations (23, 24). For example, the data transmission time can be easily measured based on hop counts or actual data transmission time from the serving base station (22) to the each of the neighbor base stations (23, 24), etc. The hop count can be defined as a number of routers through which the data transmitted from the serving base station (22) passes to each of the neighbor base stations (23, 24). The more hop counts between the serving base station (22) and the neighbor base station (23, 24), the more transmission delay can be made. Accordingly, the hop counts can be used as a means to measure the data transmission time from the serving base station (22) to each of the neighbor base stations (23, 24).

As described above, it is possible for the serving base station to acquire the information related to data transmission time and provide mobile stations with the information whenever handover is performed. It is more preferable, however, for the serving base station to store the information related to data transmission time and to provide the mobile stations with the information whenever it is needed. Further, an upper entity above a base station may manage the information related to data transmission time with respect to a plurality of base stations and provide the plurality of base stations with the information whenever it is needed.

The serving base station (22) transmits information related to the neighbor base stations (23, 24), including the information included in the HO-pre-notification response messages and the information related to data transmission time to the mobile station (21) through a handover response message [S217]. The information related to data transmission time can be expressed in a form of grade or level according to the scope of data transmission time.

The mobile station (21) performs scanning for measuring the quality of reception signals from the neighbor base stations (23, 24) which is informed by the handover response message [S218]. The quality of reception signals can be preferably strength of reference signals like pilot signals, however, bit error rates (BER) or frame error rates (FER) can also be used as the quality of reception signals.

The mobile station (21) determines a target base station for handover based on the quality of reception signal from each of the neighbor base stations (23, 24), the information related to data transmission time, and the service level prediction of each neighbor base station (23, 24) [S219]. When determining the target base station, the quality of reception signal can be the most important factor, However, when the mobile station (21) receives a delay-sensitive real time service from the serving station before handover, the information related to data transmission time is preferably to be considered importantly. For example, if the strength of reception signals from the neighbor base stations (23, 24) is similar each other, the neighbor base station having shorter data transmission time can be determined as the target base station.

An example of determining the target base station based an the quality of reception signal from each of the neighbor base stations (23, 24), the information related to data transmission time, and the service level prediction of each neighbor base station (23, 24) is described below. Three factors are weighted according to degree of importance and are expressed in a form of grade or level having different point in accordance with each grade or level such that the mobile station (21) can sum up total points of three factors for each neighbor base station and determine the neighbor base station having the highest points as the target base station. It should be understood that there can be various methods which those having ordinary skill in the art can choose as a means for determining the base station based on the three factors.

The mobile station (21) transmits information related to the determined target base station [S220], The mobile station (21) may inform the neighbor base station (24) that the neighbor base station (24) is determined to be the target base station [S221]. The serving base station (22) transfers to the target base station (24) data for the service transmitted to the mobile station (21) before handover [S222].

The serving base station (22) preferably transmits the data for the service to the mobile station during a specific time after transmitting the data for the service to the target base station [S223]. After the specific time is elapsed, the target base station (24) transmits the data for the service to the mobile station (22) [S224].

It will be apparent to those skilled in the art that various modifications and variations may be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

The service delay generated during handover between the serving base station and the target base station can be minimized by the method in accordance with the present invention. The present invention is applicable to a wireless communication system such as a broadband wireless access system, a mobile communication system, or a portable internet system, etc.

1. A method of performing handover at a mobile station (MS) receiving a service from a serving base station (BS) in a broadband wireless access system, the method comprising:
acquiring information related to data transmission time necessary for transmitting data from the serving base station to at least one neighbor base station;
determining a target base station based on at least one determination factor including the information related to data transmission time; and
receiving the service from the determined target base station.

2. The method of claim 1, wherein the information related to data transmission time is received from the serving base station.

3. The method of claim 2, wherein the information related to data transmission time is included in a handover response message.

4. The method of claim 1, further comprising measuring quality of reception signals received from the at least one neighbor base station.

5. The method of claim 4, wherein the reception signal quality is strength of the reception signals.

6. The method of claim 4, wherein the at least one determination factor further includes the reception signal quality.

7. The method of claim 6, further comprising acquiring information related to service level prediction for the service in each of the at least one neighbor base station.

8. The method of claim 7, wherein the determination factor farther includes the information related to service level prediction.

9. The method of claim 8, wherein the information related to service level prediction is received from the serving base station.

10. The method of claim 9, wherein the information related to service level prediction is included in a handover response message.

11. The method of claim 1, wherein the information related to data transmission time is hop counts from the serving base station to each of the at least one neighbor base station.

12. The method of claim 1, wherein the information related to data transmission time is actual data transmission time from the serving base station to each of the at least one neighbor base station.

13. The method of claim 11 or 12, wherein the information related to data transmission time is expressed in a form of grade or level according to scope of the data transmission time.

14. The method of claim 1, wherein the handover is a fast cell switching.

15. A method of performing handover in a mobile station (MS) comprising:
determining a target base station based on data transmission time necessary for transferring data from a serving base station to at least one neighbor base station, the data transmission time being calculated from received information from the serving base station; and
transmitting information associated with the determined target base station to the serving base station.

16. The method of claim 15, wherein information on service level prediction is further considered when determining the target base station.

17. The method of claim 16, wherein quality of reception signal from the at least one base station is further considered when determining the target base station.

18. The method of claim 5, wherein the received information is hop counts from the serving base station to each of the at least one neighbor base station.

19. The method of claim 15, wherein the received information is actual data transmission time from the serving base station to each of the at least one neighbor base station.

20. The method of claim 18 or 19, wherein the received information is expressed in a form of grade or level according to scope of the data transmission time.

21. A method of supporting handover of a mobile station (MS) receiving a service from a serving base station (BS) in a broadband wireless access system, the method comprising:
providing information related to data transmission time necessary for transmitting data from the serving base station to at least one neighbor base station;
receiving information associated with a target base station determined by the mobile station among the at least one neighbor base station based on at least one determination factor including the information related to data transmission time; and
transmitting data for the service to the target base station.

22. The method of claim 21, further comprising measuring the data transmission time from the serving base station to each of the at least one neighbor base station.

23. The method of claim 21, further comprising providing the mobile station with information related to service level prediction for the service of the at least one neighbor base station.

24. The method of claim 23, wherein the information related to data transmission time and the information related to service level prediction is included in a handover response message.

25. The method of claim 21, wherein the information related to data transmission time is hop counts from the serving base station to the at least one neighbor base station.

26. The method of claim 21, wherein the information related to data transmission time is actual data transmission time from the serving base station to each of the at least one neighbor base station.

27. The method of claim 25 or 26, wherein the information related to data transmission time is expressed in a form of grade or level according to scope of the data transmission time.

28. The method of claim 21, wherein the handover is a fast cell switching.

29. The method of claim 21, further comprising transmitting the data for the service to the mobile station during a specific time after transmitting the data for the service to the target base station.
